(19) United States
(12) Patent Application Publication
(10) Pub. No.: US 2007/0215828 A1
(43) Pub. Date: Sep. 20, 2007

(54) UNIVERSAL CONFIGURABLE VALVE

(75) Inventors: Raymond E. Cellemme JR., Matthews, NC (US); Julie C. Howell, Indian Trail, NC (US)

Correspondence Address: ADAMS EVANS P.A., Suite 2350 Charlotte Plaza, 201 South College Street, CHARLOTTE, NC, 28244, US

(73) Assignee: CONBRACO INDUSTRIES, INC., Matthews, NC (US)

(21) Appl. No.: 11/308,345

(22) Filed: Mar. 17, 2006

(51) Int. Cl. F16L 29/00

(52) U.S. Cl. 251/148

(57) ABSTRACT

A universal valve adapted to utilize various types of tailpieces. The valve includes a body having a bore therethrough, a valve element positioned in the body and moveable between an open position which permits fluid flow through the bore and a closed position which prevents fluid flow through the bore, and at least one flange nut for releasably securing a tailpiece to an end of the body. The flange nut includes a recess that defines an inner surface adapted to engage the end of the body, an axially-facing annular inner face, and a tapered annular bearing surface disposed intermediate the inner surface and the inner face.

### TECHNICAL FIELD AND BACKGROUND OF THE INVENTION

The present invention relates to the field of valves. In particular, the invention relates to a universal ball valve adapted to utilize various types of tailpieces.

Ball valves are well-known and are widely used in piping systems to provide a means for stopping the flow of fluid therein. Typically, ball valves are manufactured in sizes ranging from one-half inch to two inches, and are made of various materials such as brass and polyvinyl chloride (PVC). Additionally, ball valves include a valve body, a ball element, seats, and a stem for rotating the ball element.

To allow easy installation and protect the seats of the ball valve from thermal damage caused by welding and brazing, ball valves are being manufactured with separate tailpieces that are secured to the valve body by flange or union-type nuts. In order to establish alignment of the tailpiece and valve body flow paths, the dimensional configuration of the tailpiece must match the dimensional configuration of the flange nut. Thus, for one size of valve, several flange nuts are needed to provide interchangeability of tailpieces. If a single flange nut is used with different tailpieces, the different tailpieces may “float” within the flange nut, resulting in the valve body and tailpiece flow paths being misaligned.

Accordingly, there is a need for a ball valve that includes a single flange nut capable of receiving and maintaining various types of tailpieces in alignment with the valve body flow path.

### SUMMARY OF THE INVENTION

Therefore it is an object of the invention to provide a valve that can be used with tailpieces of different sizes.

It is another object of the invention to provide a valve that can be used with tailpieces of different materials.

It is another object of the invention to provide a valve that includes flange nuts capable of securing different tailpieces to and in alignment with the valve body.

These and other objects of the present invention are achieved in the preferred embodiments disclosed below by providing a valve including a body having a bore passing therethrough; a valve element disposed in the body and moveable between an open position which permits fluid flow through the bore and a closed position which prevents fluid flow through the bore; and at least one flange nut for releasably securing a tailpiece to an end of the body. The flange nut including a recess that defines an inner surface adapted to engage the end of the body; an axially-facing annular inner face; and a tapered annular bearing surface disposed intermediate the inner surface and the inner face.

According to another preferred embodiment of the invention, the flange nut includes an end wall which defines the inner face and a skirt extending axially away from the end wall.

According to another preferred embodiment of the invention, the bearing surface is positioned at an angle between an inner surface and the inner face to define a conical chamfer.

According to another preferred embodiment of the invention, the end wall includes an aperture for receiving a pipe connecting section of a tailpiece therethrough.

According to another preferred embodiment of the invention, the valve element is a ball.

According to another preferred embodiment of the invention, the valve element is a gate.

According to another preferred embodiment of the invention, a valve assembly includes a valve. The valve including a body having a bore passing therethrough; a valve element disposed in the body and moveable between an open position which permits fluid flow through the bore and a closed position which prevents fluid flow through the bore; and a first flange nut releasably engaged with a first end of the body. The first flange nut having a recess including a tapered annular bearing surface and an axially-facing annular inner face. The valve assembly further including a first tailpiece having a flange for being received by the recess and secured to and aligned with the body, wherein the flange of the first tailpiece has a cross-sectional profile different than a cross-sectional profile of the recess.

According to another preferred embodiment of the invention, further including a second flange nut releasably engaged with a second end of the body, the second flange nut having a recess including a tapered annular bearing surface and an axially-facing annular inner face.

According to another preferred embodiment of the invention, and further including a second tailpiece having a flange for being received by the recess of the second flange nut and secured to and aligned with the body, wherein the flange of the second tailpiece has a cross-sectional profile different than the cross-sectional profile of the recess of the second flange nut.

According to another preferred embodiment of the invention, further including a second tailpiece having a flange for being received by the recess of the second flange nut and secured to and aligned with the body, wherein the flange of the second tailpiece has a cross-sectional profile complimentary to the cross-sectional profile of the recess of the second flange nut

According to another preferred embodiment of the invention, the first tailpiece is made of a different material than the second tailpiece.

According to another preferred embodiment of the invention, the first flange nut includes an end wall which defines the inner face and a skirt extending axially away from the end wall, the end wall including an aperture for receiving a pipe connecting section of the first tailpiece therethrough.

According to another preferred embodiment of the invention, the second flange nut includes an end wall which defines the inner face and a skirt extending axially away from the end wall, the end wall including an aperture for receiving a pipe connecting section of a second tailpiece therethrough

According to another preferred embodiment of the invention, wherein the bearing surface engages an outer edge of the flange to align the first tailpiece with the bore of the body.

According to another preferred embodiment of the invention, the first and second tailpieces each include a pipe connecting section.

According to another preferred embodiment of the invention, a method for assembling a valve assembly includes the steps of providing a valve. The valve including a body having a bore passing therethrough; a valve element disposed in the body and moveable between an open position and a closed position; and a first flange nut adapted to releasably engage a first end of the body, the first flange nut having a recess including a tapered annular bearing surface and an axially-facing annular inner face. The method further including the steps of selecting a first tailpiece having a flange with a cross-sectional profile different than a cross-sectional profile of the recess, and a pipe connecting section; positioning the pipe connecting section through an aperture in an end wall of the first flange nut such that the flange is positioned within the recess; and attaching the first flange nut to the first end of the body, wherein the bearing surface and inner face align and press the first tailpiece to the body.

According to another preferred embodiment of the invention, the valve further includes a second flange nut releasably engaged with a second end of the body, the second flange nut having a recess including a tapered annular bearing surface and an axially-facing annular inner face.

According to another preferred embodiment of the invention, further including the step of selecting a second tailpiece having a flange with a cross-sectional profile different than a cross-sectional profile of the recess of the second flange nut.

According to another preferred embodiment of the invention, further including the step of positioning a pipe connecting section of the second tailpiece through an aperture in an end wall of the second flange nut such that the flange of the second flange nut is positioned within the recess, and attaching the second flange nut to the second end of the body, wherein the bearing surface and inner face of the second flange nut align and press the second tailpiece to the body.

According to another preferred embodiment of the invention, further including the step of selecting a second tailpiece having a flange with a cross-sectional profile complimentary to the cross-sectional profile of the recess of the second flange nut.

According to another preferred embodiment of the invention, further including the step of selecting a second tailpiece having a cross-sectional profile different from the cross-sectional profile of the first tailpiece.

According to another preferred embodiment of the invention, further including the step of selecting a second tailpiece made of a material different from the material of the first tailpiece.

### BRIEF DESCRIPTION OF THE DRAWINGS

The invention may be best understood by reference to the following description in conjunction with the accompanying drawing figures in which:

FIG. 1 is a cross-section of a valve according to an embodiment of the invention;

FIG. 2 is a plan view of a flange nut of the valve of FIG. 1;

FIG. 3 is a cross-section of the flange nut of FIG. 2;

FIG. 4 is a plan view of a tailpiece for use with the valve of FIG. 1;

FIG. 5 is a cross-section of the tailpiece of FIG. 4;

FIG. 6 is a plan view of a tailpiece for use with the valve of FIG. 1;

FIG. 7 is a cross-section of the tailpiece of FIG. 6;

FIG. 8 is a plan view of a tailpiece for use with the valve of FIG. 1;

FIG. 9 is a cross-section of the tailpiece of FIG. 8;

FIG. 10 is a cross-section of the valve of FIG. 1 with the tailpieces of FIGS. 5 and 7 secured thereto;

FIG. 11 is a cross-section of the valve of FIG. 1 with tailpieces secured thereto; and

FIG. 12 is a cross-section of the valve of FIG. 1 with the tailpieces of FIGS. 5 and 9 secured thereto.

### DESCRIPTION OF THE PREFERRED EMBODIMENT AND BEST MODE

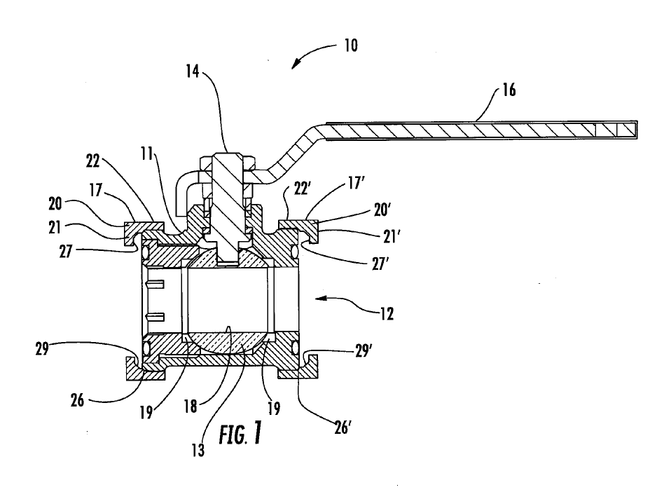

Referring now specifically to the drawings, a ball valve according to an embodiment of the invention is illustrated in FIG. 1 and shown generally at reference numeral 10. The ball valve 10 includes a valve body 11 having a bore 12 extending therethrough, a ball element 13 positioned in the bore 12, a stem 14 extending into the bore 12 for engaging and rotating the ball element 13, a handle 16 for rotating the stem 14, and flange nuts 17 and 17′ for releasably securing different types of tailpieces to opposing ends of the valve body 11. While this invention is being described with reference to a ball valve, it should be appreciated that the invention applies to other valve-types, such as gate valves, using flange nuts to secure tailpieces.

As shown, the ball element 13 includes an aperture 18 extending therethrough and in alignment with the bore 12 to permit fluid to flow through the valve 10. When the ball element 13 is rotated 90 degrees, the aperture 18 is positioned perpendicular to the bore 12, thereby interrupting the flow of fluid through the valve 10. Seats 19 are positioned between the ball element 13 and an interior surface of the valve body 11 to provide a seal therebetween and prevent fluid from leaking around the ball element 13.

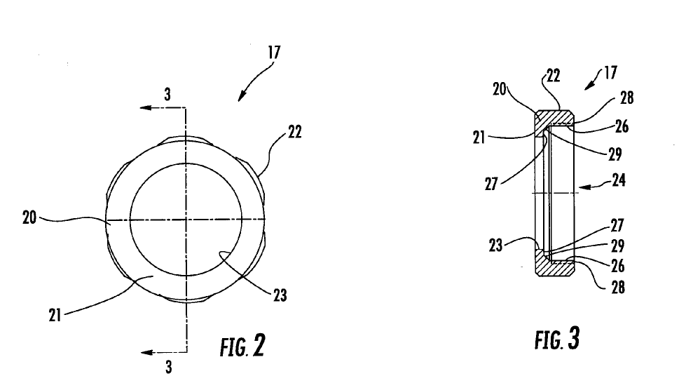

Referring to FIGS. 2 and 3, flange nuts 17 and 17′ are identical, thus, for purposes of this discussion, only flange nut 17 will be described. The flange nut 17 includes an end wall 20 defining an outer face 21. A skirt 22 is integrally-formed with and extends axially away from the end wall 20. An aperture 23 is formed through the end wall 20 and is adapted to receive a pipe connecting section of a tailpiece therethrough.

As shown in FIG. 3, a recess 24 having a diameter slightly larger than the diameter of the aperture 23 is defined by an inner surface 26 of the skirt 22 and an axially-facing annular inner face 27 of the end wall 20 for receiving a uniform flange of a tailpiece. The inner surface 26 is adapted to allow the flange nut 17 to engage an end of the valve body 11. As illustrated, threads 28 are incorporated into the inner surface 26 to allow the flange nut 17 to be threaded onto an end of the valve body 11. A tapered annular bearing surface 29 is formed between the inner surface 26 and the inner face 27.

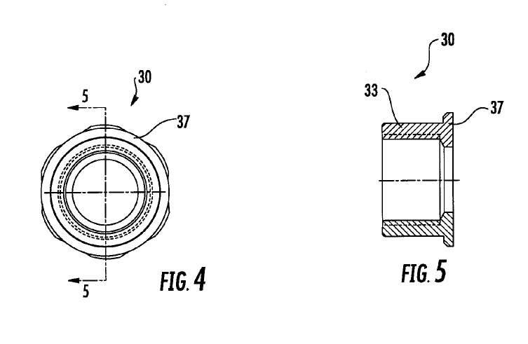

Examples of three different types of tailpieces 30, 31, and 32 are shown in FIGS. 4-5, 6-7, and 8-9, respectively. Each of the tailpieces 30, 31, and 32 include a pipe connecting section 33, 34, and 35, and a substantially uniform flange 37, 38, and 39. Each of the tailpieces 30, 31, 32 are discussed below with reference to the valve 10.

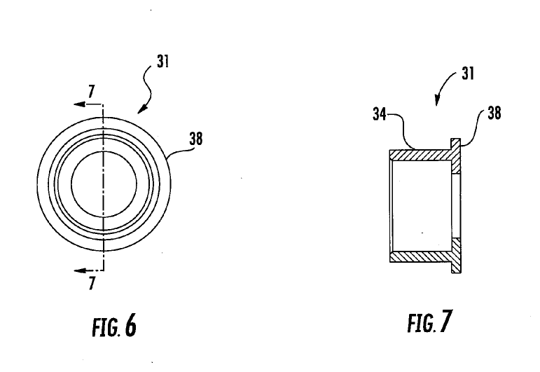

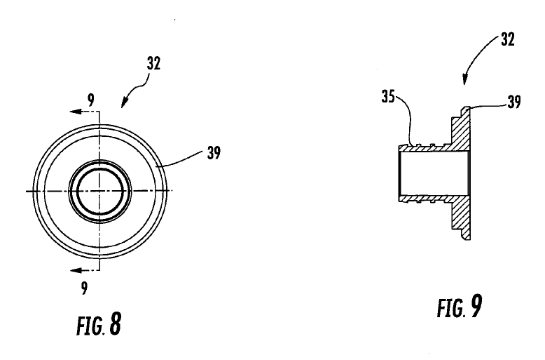

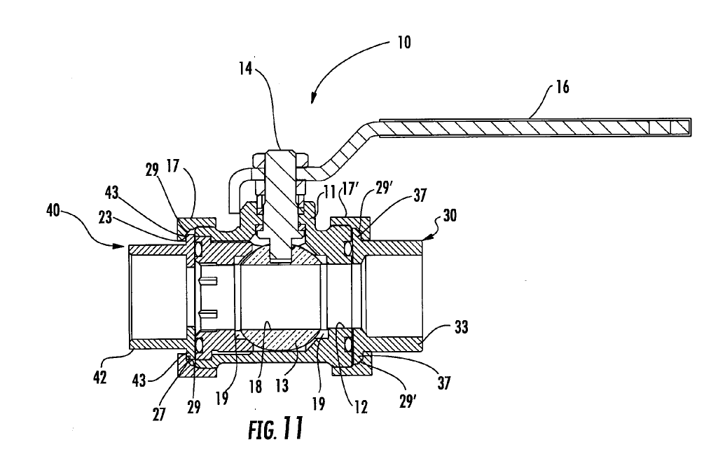

Referring to FIG. 10, the flange nuts 17 and 17′ allow different types of tailpieces to be secured to the valve 10 at the same time to form a valve assembly. As illustrated, the tailpiece 31 of FIGS. 6 and 7 is secured to the valve body 11 by flange nut 17 and the tailpiece 30 of FIGS. 4 and 5 is secured to the valve body 11 by flange nut 17′. Because the bearing surfaces 29 and 29′ of the flange nuts 17 and 17′ provide a gradual bearing surface, a tailpiece with a flange having a non-complimentary square cross-sectional profile, i.e. tailpiece 31, can be secured and aligned just like a tailpiece having a flange with a complimentary cross-sectional profile, i.e. tailpiece 30.

As illustrated, the bearing surface 29 engages an outer edge of the flange 38 to secure the tailpiece 31 to the valve body 11. Because the flange 38 is substantially uniform, the bearing surface 29 aligns the tailpiece 31 with the bore 12 of the valve body 11.

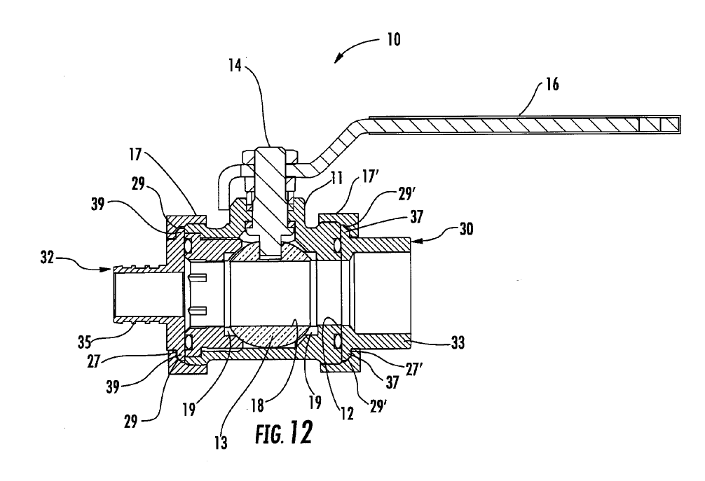

As shown in FIG. 11, a smaller tailpiece 40 may also be secured to and aligned with the valve body 11. The tailpiece 40 is similar in design to the tailpiece 31 except the diameter of the tailpiece 40 is smaller than the tailpiece 31. As illustrated, the tailpiece 40 has a pipe connecting section 42 and a flange 43. The diameter of the pipe connecting section 42 is smaller than the diameter of the aperture 23 of the flange 17. Typically, this would result in the tailpiece 40 “floating,” thereby preventing the tailpiece 40 from being in alignment with the bore 12 of the valve body 11. However, the bearing surface 29 and inner face 27 cooperate to secure the tailpiece 40 to and align it with the valve body 11. As shown, the bearing surface 29 acts as a stop to prevent the flange 43 from floating while the inner face 27 presses the flange 43 against the valve body 11.

In addition to securing tailpieces of different profiles and sizes, the flange nuts 17 and 17′ can also secure tailpieces of different material. For example, the tailpiece of FIGS. 6 and 7 may be made of PVC and the tailpiece of FIGS. 4 and 5 may be made of brass.

In use, the valve 10 allows an individual to purchase one valve and a plurality of tailpieces. Thus, an individual can purchase a one inch valve 10 for use in a piping system and then purchase the tailpieces of his/her choice. This allows the individual to use the valve 10 to step down from one inch to one-half inch piping or to go from hard piping to plastic piping or tubing using a single valve.

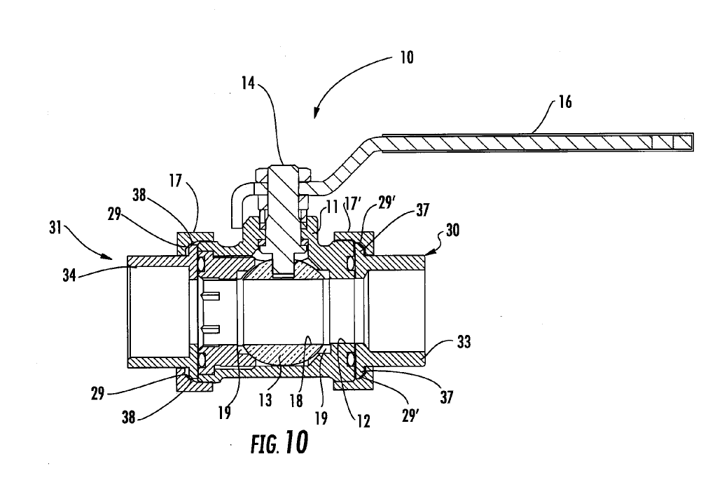

For example, as shown in FIG. 12, an individual can use the valve 10 to transition from hard pipe, i.e. carbon steel piping, to flexible tubing. In this scenario, the tailpiece 32 of FIGS. 8 and 9 is secured to and aligned with the valve body 11 by the flange nut 17 and the tailpiece 30 of FIGS. 4 and 5 is secured to and aligned with the valve body 11 by the flange nut 17′. The tailpiece 30 is adapted for use with hard piping, and may be connected to such piping by socket-welding, gluing, or threads. The tailpiece 32 is adapted for use with tubing, and may be connected to such tubing by sliding the tubing over the pipe connecting section 39 and then clamping the tubing to the pipe connecting section 39.

A universal configurable valve is described above. Various details of the invention may be changed without departing from its scope. Furthermore, the foregoing description of the preferred embodiments of the invention and best mode for practicing the invention are provided for the purpose of illustration only and not for the purpose of limitation.

What is claimed is:

1. A valve, comprising:
(a) a body having a bore passing therethrough;
(b) a valve element disposed in the body and moveable between an open position which permits fluid flow through the bore and a closed position which prevents fluid flow through the bore; and
(c) at least one flange nut for releasably securing a tailpiece to an end of the body, the flange nut including a recess defining:
(i) an inner surface adapted to engage the end of the body;
(ii) an axially-facing annular inner face; and
(iii) a tapered annular bearing surface disposed intermediate the inner surface and the inner face.

2. The valve according to claim 1, wherein the flange nut includes an end wall which defines the inner face and a skirt extending axially away from the end wall.

3. The valve according to claim 1, wherein the bearing surface is positioned at an angle between an inner surface and the inner face to define a conical chamfer.

4. The valve according to claim 2, wherein the end wall includes an aperture for receiving a pipe connecting section of a tailpiece therethrough.

5. The valve according to claim 1, wherein the valve element is a ball.

6. The valve according to claim 1, wherein the valve element is a gate.

7. A valve assembly, comprising:
(a) a valve, comprising:
(i) a body having a bore passing therethrough;
(ii) a valve element disposed in the body and moveable between an open position which permits fluid flow through the bore and a closed position which prevents fluid flow through the bore;
(iii) a first flange nut releasably engaged with a first end of the body, the first flange nut having a recess including a tapered annular bearing surface and an axially-facing annular inner face; and
(b) a first tailpiece having a flange for being received by the recess and secured to and aligned with the body, wherein the flange of the first tailpiece has a cross-sectional profile different than a cross-sectional profile of the recess.

8. The valve assembly according to claim 7, and further including a second flange nut releasably engaged with a second end of the body, the second flange nut having a recess including a tapered annular bearing surface and an axially-facing annular inner face.

9. The valve assembly according to claim 8, and further including a second tailpiece having a flange for being received by the recess of the second flange nut and secured to and aligned with the body, wherein the flange of the second tailpiece has a cross-sectional profile different than the cross-sectional profile of the recess of the second flange nut.

10. The valve assembly according to claim 8, and further including a second tailpiece having a flange for being received by the recess of the second flange nut and secured to and aligned with the body, wherein the flange of the second tailpiece has a cross-sectional profile complimentary to the cross-sectional profile of the recess of the second flange nut.

11. The valve according to claim 9 or 10, wherein the first tailpiece is made of a different material than the second tailpiece.

12. The valve assembly according to claim 7, wherein the first flange nut includes an end wall which defines the inner face and a skirt extending axially away from the end wall, the end wall including an aperture for receiving a pipe connecting section of the first tailpiece therethrough.

13. The valve assembly according to claim 8, wherein the second flange nut includes an end wall which defines the inner face and a skirt extending axially away from the end wall, the end wall including an aperture for receiving a pipe connecting section of a second tailpiece therethrough.

14. The valve assembly according to claim 7, wherein the bearing surface is positioned at an angle between the inner surface and the inner face to define a conical chamfer.

15. The valve assembly according to claim 7, wherein the bearing surface engages an outer edge of the flange to align the first tailpiece with the bore of the body.

16. The valve assembly according to claim 9 or 10, wherein the first and second tailpieces each include a pipe connecting section.

17. A method for assembling a valve assembly, comprising the steps of:
(a) providing a valve, comprising:
(i) a body having a bore passing therethrough;
(ii) a valve element disposed in the body and moveable between an open position and a closed position;
(iii) a first flange nut adapted to releasably engage a first end of the body, the first flange nut having a recess including a tapered annular bearing surface and an axially-facing annular inner face;
(b) selecting a first tailpiece having a flange with a cross-sectional profile different than a cross-sectional profile of the recess, and a pipe connecting section;
(c) positioning the pipe connecting section through an aperture in an end wall of the first flange nut such that the flange is positioned within the recess;
(d) attaching the first flange nut to the first end of the body, wherein the bearing surface and inner face align and press the first tailpiece to the body.

18. The method according to claim 17, wherein the valve further includes a second flange nut releasably engaged with a second end of the body, the second flange nut having a recess including a tapered annular bearing surface and an axially-facing annular inner face.

19. The method according to claim 18, and further including the step of selecting a second tailpiece having a flange with a cross-sectional profile different than a cross-sectional profile of the recess of the second flange nut.

20. The method according to claim 19, and further including the step of positioning a pipe connecting section of the second tailpiece through an aperture in an end wall of the second flange nut such that the flange of the second flange nut is positioned within the recess, and attaching the second flange nut to the second end of the body, wherein the bearing surface and inner face of the second flange nut align and press the second tailpiece to the body.

21. The method according to claim 18, and further including the step of selecting a second tailpiece having a flange with a cross-sectional profile complimentary to the cross-sectional profile of the recess of the second flange nut.

22. The method according to claim 21, and further including the step of positioning a pipe connecting section of the second tailpiece through an aperture in an end wall of the second flange nut such that the flange of the second flange nut is positioned within the recess, and attaching the second flange nut to the second end of the body, wherein the bearing surface and inner face of the second flange nut align and press the second tailpiece to the body.

23. The method according to claim 18, and further including the step of selecting a second tailpiece having a cross-sectional profile different from the cross-sectional profile of the first tailpiece.

24. The method according to claim 23, and further including the step of positioning a pipe connecting section of the second tailpiece through an aperture in an end wall of the second flange nut such that the flange of the second flange nut is positioned within the recess, and attaching the second flange nut to the second end of the body, wherein the bearing surface and inner face of the second flange nut align and press the second tailpiece to the body.

25. The method according to claim 18, and further including the step of selecting a second tailpiece made of a material different from the material of the first tailpiece.

26. The method according to claim 25, and further including the step of positioning a pipe connecting section of the second tailpiece through an aperture in an end wall of the second flange nut such that the flange of the second flange nut is positioned within the recess, and attaching the second flange nut to the second end of the body, wherein the bearing surface and inner face of the second flange nut align and press the second tailpiece to the body.
